(19) United States
(12) Patent Application Publication
(10) Pub. No.: US 2023/0057009 A1
(43) Pub. Date: Feb. 23, 2023

(54) CARBON FOOTPRINT REDUCTION VIA CETACEAN PROTECTION

(71) Applicant: KYNDRYL, INC., New York, NY (US)

(72) Inventors: Laxmikantha Sai Nanduru, R K Puram Post (IN); Pritpal S. Arora, Bangalore (IN); Sarbajit K. Rakshit, Kolkata (IN); Reena Nagrale, Pune (IN)

(21) Appl. No.: 17/406,561

(22) Filed: Aug. 19, 2021

(51) Int. Cl. A01K 29/00; A01K 61/90; B63B 51/00

(52) U.S. Cl. CPC A01K 29/005; A01K 61/90; B63B 51/00

(57) ABSTRACT

A system may include a memory and a processor in communication with the memory. The processor may be configured to perform operations. The operations may include collecting organism data and analyzing the organism data. The operations may also include predicting a organism movement pattern based on the organism data and relaying the organism movement pattern to a participant.

### BACKGROUND

The present disclosure relates to atmospheric content and more specifically to carbon dioxide content in the atmosphere.

Cetaceans impact atmospheric content, including atmospheric carbon dioxide. Cetaceans accumulate carbon in their bodies throughout their lives, sequestering an estimated thirty-three tons of carbon dioxide per cetacean which would otherwise be in the atmosphere contributing to the greenhouse gas effect. Cetacean populations are currently in decline. Slowing and reversing the decline of cetacean populations may help to protect the environment, including the atmospheric content.

### SUMMARY

Embodiments of the present disclosure include a system, method, and computer program product for reducing the concentrations of carbon dioxide in the atmosphere.

A system may include a memory and a processor in communication with the memory. The processor may be configured to perform operations. The operations may include collecting organism data and analyzing the organism data. The operations may also include predicting an organism movement pattern based on the organism data and relaying the organism movement pattern to a participant.

The above summary is not intended to describe each illustrated embodiment or every implement of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a system in accordance with some embodiments of the present disclosure.

FIG. 2 depicts a subsystem in accordance with some embodiments of the present disclosure.

FIG. 3 illustrates a subsystem in accordance with some embodiments of the present disclosure.

FIG. 4 depicts a method in accordance with some embodiments of the present disclosure.

FIG. 5 illustrates a method in accordance with some embodiments of the present disclosure.

FIG. 6 depicts a cloud computing environment, in accordance with embodiments of the present disclosure.

FIG. 7 illustrates abstraction model layers, in accordance with embodiments of the present disclosure.

FIG. 8 depicts a high-level block diagram of an example computer system that may be used in implementing one or more of the methods, tools, and modules, and any related functions, described herein, in accordance with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to atmospheric content and more specifically to carbon dioxide content in the atmosphere.

Organisms impact atmospheric content, including atmospheric carbon dioxide. Carbon-based life forms store carbon in their bodies. Large organisms, such as cetaceans, may have a particular impact on storing carbon that might otherwise be in the atmosphere due to their large size. Organisms may contribute to atmospheric balance (e.g., reduction of carbon dioxide and increase of oxygen) in other ways as well. Some organisms, for example, consume carbon-based nutrients and release oxygen as a by-product.

Cetaceans include species such as whales, porpoises, dolphins, and the like. Cetaceans accumulate carbon dioxide through feeding. Cetaceans bring minerals from within the ocean up to the surface through their vertical movement; this process is often referred to as the whale pump. Cetaceans have a multiplier effect of increasing phytoplankton production wherever they go.

Phytoplankton are microscopic organisms that contribute at least 50 percent of all oxygen released into our atmosphere by capturing carbon dioxide. It is estimated that phytoplankton capture about 37 billion metric tons of carbon dioxide annually, an estimated 40 percent of all carbon dioxide produced. Thus, more phytoplankton means more carbon captured and removed from the atmosphere; simultaneously, more phytoplankton means more oxygen released into the atmosphere.

It has been estimated that more than 80 endangered whales are killed by ships each year along the western coastline of the United States. Ships that strike cetaceans are often unaware of any collisions until reaching port. Such collisions can be avoided by increasing awareness of cetaceans. Reducing collisions with cetaceans can help to maintain and grow cetacean populations and, as a result, reduce atmospheric carbon. A system in accordance with the present disclosure may assist in reducing collisions with wildlife, including reducing collisions with cetaceans.

Cetaceans may be located, mapped, and tagged. Tagging cetaceans may be useful for tracking, monitoring, and protection. Phytoplankton concentrations may also be mapped, and navigation of cetaceans may be facilitated toward regions that are relatively safe (e.g., ocean regions with minimal shipping traffic) and have food chain support (e.g., where there are concentrations of phytoplankton, zooplankton, planktivores, piscivores, pinnipeds, and other oceanic life reflective of a food chain which would support cetaceans).

Cetacean movement may be monitored via global positioning system (GPS) technology or similar equipment. Information gathered about cetacean movement may be used to inform, guide, and/or control seafaring vessels. Using the information gathered in this way can help prevent accidental collisions of ships with cetaceans.

Equipment may be used to locate and track cetaceans. Equipment used may include, for example, satellites, sonar receivers aboard special purpose oceanic research vessels, sonar equipment aboard other ships, and the like. Ships traversing an ocean may continuously identify, listen to, and/or track auditory signals emanating from cetaceans. Upon detection of one or more cetaceans, onboard radar may monitor the movement of the cetaceans including the location of the cetaceans, the distance the cetaceans are from any nearby shoreline, the distance the cetaceans are from any ships in the area, and the like. The radar may also track the velocity of the cetaceans, including the speed at which they are moving and the direction in which the cetaceans are traveling.

The location data of the cetaceans may be used enable ships to circumnavigate the cetaceans and/or to otherwise avoid collision with the animals. This information may be shared with one or more organizations to better equip the organizations to monitor, protect, and otherwise provide safety to the cetaceans.

In some cases, it may be desirable to capture and monitor the locations of high carbon dioxide presence. The information may be communicated with a global carbon dioxide monitoring organization. A global carbon footprint map may be correlated with a map of the cetacean ecosystem and/or movement and migratory patterns to assist in identifying where best to guide cetaceans.

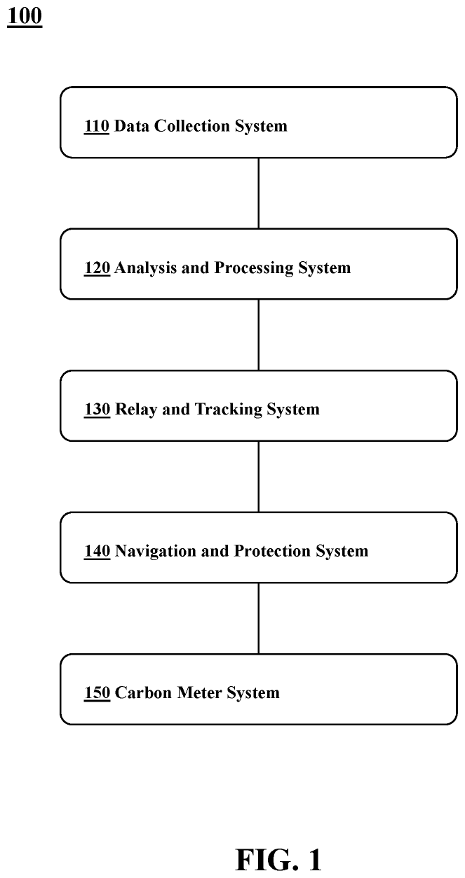

FIG. 1 illustrates a system 100 in accordance with some embodiments of the present disclosure. The system 100 includes a data collection system 110, an analysis and processing system 120, a relay and tracking system 130, a navigation and protection system 140, and a carbon meter system 150.

The system 100 in accordance with some embodiments of the present disclosure may include the data collection system 110. The data collection system 110 may include various types of equipment for gathering information. The data collection system 110 may, for example, gather information from public data repositories concerning historical weather, typical shipping routes, oceanic habitats, migration locations of one or more migratory species, and the like. The data collection system 110 may include various data collecting equipment such as, for example, satellite receivers, image processors, audio detectors, sonar devices, communication systems, radio transmitters, optical telemetry transmitters, and the like.

The system 100 may include the analysis and processing system 120. The analysis and processing system 120 may process and/or analyze the data collected by the data collection system 110 to develop insights about the data collected. The analysis and processing system 120 may, for example, track where certain migratory species have been and are likely to go based on prior migratory locations of the species. The analysis and processing system 120 may, for example, cross-reference the migration locations of the species to historical weather data to identify how weather patterns might be associated with the migratory patterns of that species.

The system 100 may include the relay and tracking system 130. The relay and tracking system 130 may relay information to various entities such as vessels in an areas of interest (e.g., an area with cetacean activity), governmental agencies (e.g., a committee overseeing the protection of one or more species of cetaceans), organizations (e.g., a non-profit collecting data to track a cetacean species, or a group tracking carbon footprint data), and other interested parties. The relay and tracking system 130 may include various equipment such as, for example, communication systems, radio transmitters, optical telemetry transmitters, and the like.

The system 100 may include the navigation and protection system 140. The navigation and protection system 140 may include components to assist in routing, re-routing, and otherwise guiding watercraft (e.g., ships) away from cetacean locations to prevent collisions. These locations may be current locations of cetaceans, areas of high cetacean activity historically, predicted cetacean locations, or similar areas of concern. The navigation and protection system 140 may include components to inform policy formation at various levels of government. Policy may be guided, for example, by providing information about cetacean migratory patterns paired with recommendations about shipping route changes to minimize collisions and/or minimize the necessity of re-routing ships already en route to prevent collisions with cetaceans.

The system 100 may include the carbon meter system 150. The carbon meter system 150 may map regional and/or global carbon (e.g., carbon dioxide). The carbon meter system 150 may correlate such a carbon map with cetacean presence and/or activity. The carbon meter system 150 may track the changes in carbon over time, and the carbon meter system 150 may distill data about such changes based on other data collected (e.g., cetacean presence and/or activity).

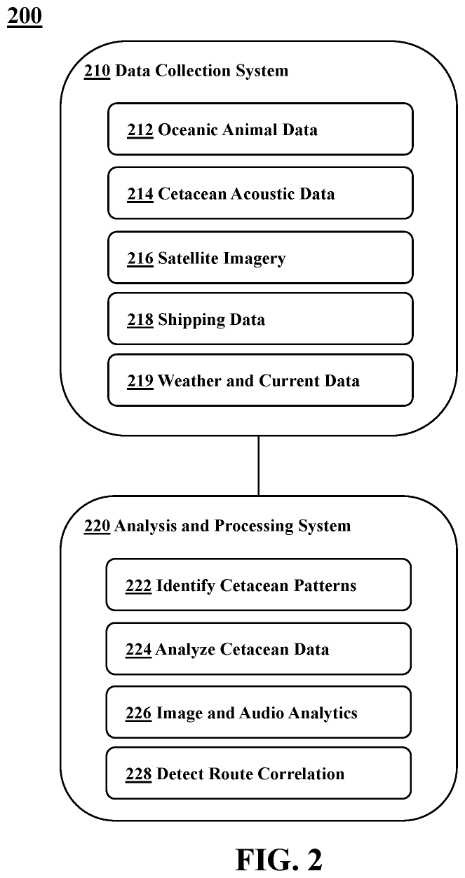

FIG. 2 depicts a subsystem 200 in accordance with some embodiments of the present disclosure. The subsystem 200 may include a data collection system 210 and an analysis and processing system 220. In some embodiments, the data collection system 210 and the analysis and processing system 220 may be the same or substantially similar to the data collection system 110 and the analysis and processing system 120 of FIG. 1.

The subsystem 200 in accordance with some embodiments of the present disclosure may include the data collection system 210. The data collection system 210 may collect oceanic animal data 212, cetacean acoustic data 214, satellite imagery 216, shipping data 218, weather and ocean current data 219, and/or other information which may be relevant to the movements of cetaceans, the ships the cetaceans may collide with, and the like.

The data collection system 210 may gather input data and insights. The information gathered may provide for informed policy modeling and/or interventions. Using satellites and/or oceanic (e.g., ship-based) monitoring equipment, the data collection system 200 may count and/or estimate the number of cetaceans in one or more regions of ocean. The cetaceans may be biologically tagged for continuous monitoring to improve the accuracy of data collection and cetacean movement predictions. Various sensors and/or other equipment may also be used to augment data collection by the data collection system 210.

The data collection system 210 may gather information about one or more cetacean families and/or classes including their characteristics such as audio signatures, imagery, habitat, food chains, direct and indirect threats to their existence, and the like. The data collection system 210 may estimate secondary data such as fatality rates, growth rates, and the like; alternatively, the data collection system 210 may collect the data and submit it to the analysis and processing system 220 to estimate secondary data.

The data collection system 210 may collect audio data (e.g., acoustic signatures of cetacean families). Audio data may be collected, for example, from ship and shore-based monitoring instruments. The data collection system 210 may monitor and/or track and the movement of one or more cetaceans. The data collection system 210 may correlate cetacean migratory patterns and other movement based on seasons, weather, and other events. The data collection system 219 may gather global carbon footprint maps and/or other information which may track atmospheric content, changes, or similar metrics.

The subsystem 200 may include an analysis and processing system 220. The analysis and processing system 220 may identify cetacean patterns 222, analyze cetacean data 224, perform image and audio analytics 226, and detect route correlations 228.

The analysis and processing system 220 may perform analytics and correlational analysis of data collected by the data collection system 210. In some embodiments, the analysis and processing system 220 may analyze satellite imagery of oceans to detect and code cetacean presence and concentrations of cetaceans in one or more regions.

In some embodiments, the analysis and processing system 220 may estimate secondary data such as fatality rates, growth rates, and the like. The analysis and processing system 220 may analyze the locations of cetacean families vis-à-vis the presence of their food chain in the oceans and conducive weather conditions.

In some embodiments, the analysis and processing system 220 may correlate a number of cetaceans in one or more regions with the weather patterns, ocean conditions, and shipping presence in the regions; this correlation may be done using time series data. The analysis and processing system 220 may correlate global weather data to analyze the movement of cetaceans in oceans as seasons change throughout the year. The analysis and processing system 220 may analyze geography and weather conditions that sustain cetacean populations in various regions using telemetry data; such data may be correlated with cetacean growth and fatality information.

In some embodiments, the analysis and processing system 220 may analyze global carbon footprint maps and superimpose satellite imagery of cetacean concentrations on them to identify the correlations between cetacean presence and carbon footprint. The analysis and processing system 220 may superimpose global shipping routes on satellite imagery of cetacean concentrations and perform analytics to draw inferences about the impact of shipping routes on cetacean populations and their presence in regions where ships navigate.

The analysis and processing system 220 may correlate cetacean concentrations to events such as volcanic eruptions, mineral exploration, scientific experiments, and major governmental activities in an oceanic region. In some embodiments, the analysis and processing system 220 may analyze data about fishing patterns of nations around the world and correlate it with cetacean presence. For example, performing such an analysis may readily reveal low cetacean concentrations in and near certain exclusive economic oceanic zones.

The analysis and processing system 220 may develop inferences from correlational analysis and various predictive, what-if scenarios. In some instances, certain cetaceans may prefer a specific water temperature such that a correlation may be established between water temperature and the types of cetaceans that may be expected; thus, if a change in currents is identified that changes the temperature of the water, an inference may be developed to predict that cetaceans may change routes. For example, humpback whales (scientific classification Megaptera novaeangliae) may prefer temperatures of 20-30 degrees Celsius; if a water current of 5 degrees Celsius moving into the normal migration route of a humpback whale pod, the humpback whales may alter course towards warmer waters, and the analysis and processing system 220 may identify the change in water temperature and predict the new route of the humpback whale pod. In another example, narwhals (scientific classification Monodon monoceros) may prefer water temperatures between 0 degrees Celsius and 2 degrees Celsius; the analysis and processing system 220 may identify warm water currents of 10 degrees Celsius moving into a narwhal migration route and predict the route the impacted narwhal pod will use to stay in cooler waters. By identifying correlational data, developing inferences, and predicting behavior of organisms, the analysis and processing system 220 may anticipate pattern variations and direct ships accordingly.

The analysis and processing system 220 may model the growth of cetacean populations and the multiplier effect on the increase of phytoplankton production due to the whale pump effect. For example, the analysis and processing system 220 may identify a migrating pod of blue whales (scientific classification Balaenoptera musculus) and predict an increase in the phytoplankton population as a result of the whale pump effect. In another example, the migration of a pod of common dolphins (scientific classification Delphinus delphis) may have a different impact on phytoplankton population because it has a different diet. When common dolphins pass through an area, the phytoplankton population may not substantially decrease because the common dolphins may consume other resources; additionally, the phytoplankton population may not increase as quickly after the common dolphins pass through the area compared to blue whales because the common dolphins may not leave behind as many resources to encourage growth of the phytoplankton. The analysis and processing system 220 may thus predict the changes in phytoplankton population based on the whale pump effect of a particular cetacean.

The analysis and processing system 220 may model and predict the reduction in fatalities of cetaceans attributable to various correctional actions; in some embodiments, the analysis and processing system 220 may use multivariate regression methods to make models and/or predictions. Variables that the analysis and processing system 220 may consider may include oceanic shipping routes, types of ships and carriers, collision avoidance systems in ships and carriers to prevent cetacean collisions, cetacean food chain disruption and minimization of human-caused disruptions, illegal whaling and preventative measures taken to combat it, cetacean stranding prevention measures, and similar variables.

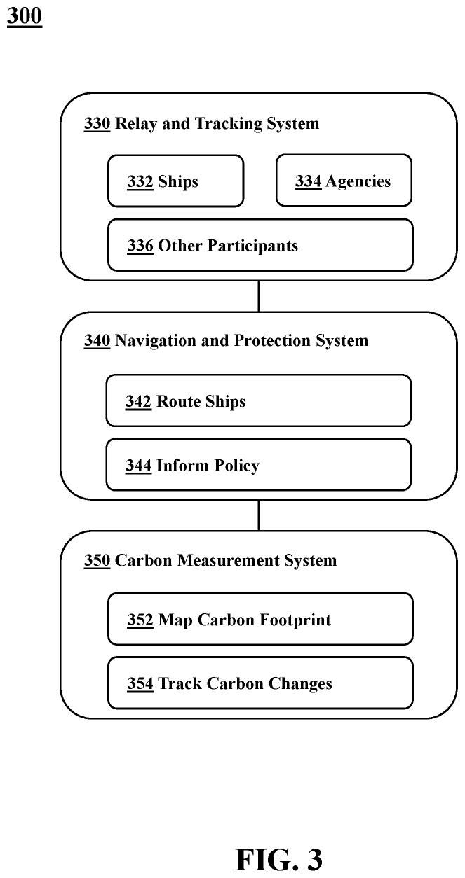

FIG. 3 illustrates a subsystem 300 in accordance with some embodiments of the present disclosure. The subsystem 300 may include a relay and tracking system 330, a navigation and protection system 340, and a carbon measurement system 350. In some embodiments, the relay and tracking system 330, the navigation and protection system 340, and the carbon measurement system 350 may be the same or substantially similar to the relay and tracking system 130, the navigation and protection system 140, and the carbon measurement system 150 of FIG. 1.

The relay and tracking system 330 may relay information to ships 332, agencies 334, and other participants 336. Ships 332 may include vessels currently in the region of tracked cetaceans, boats on an intercept course with projected cetacean movement, and other watercraft which may be able to use the information. The agencies 334 may include, for example, government agencies, agencies responsible for directing water traffic, environmental agencies, research groups, and the like. The other participants 336 may include organizations identified as important stakeholders such as government officials, organizations that decide on water traffic routes, groups responsible for communicating water traffic routes, other groups or individuals interested in the observed organisms and/or atmospheric content, scientists, travel planners, whale watching groups, tourists, and the like.

The navigation and protection system 340 may route ships 342 directly, such as by notifying the captain and/or crew of a ship of a nearby cetacean pod and an alternative route to avoid collision with the cetaceans. The navigation and protection system 340 may be used to inform policy 344, such as by submitting reports to regulating organizations that develop policies so that the organizations may use the data in the reports to better formulate the policies. For example, a system (such as system 100 as shown in FIG. 1) may collect and analyze data to identify that collisions with north Atlantic right whales (scientific classification Eubalaena glacialis) occur relatively frequently during the month of May in the Atlantic ocean along the 40^{th} longitudinal parallel; the navigation and protection system 340 may recommend altering shipping routes for ships in the area of interest during the month of May to avoid collisions with the north Atlantic right whales.

By informing policy and in similar ways, the navigation and protection system 340 may be used to develop protective frameworks for cetacean families. Analytics and correlative analysis derived from collected data (e.g., information collected via the data collection system 210 in FIG. 2) may be used to determine shipping routes, including seasonal routes if cetaceans are in certain areas during certain times of the year. Analytics and correlative analysis may also be used to identify types and sizes of ships, containers, and other water vessels that adversely impact the ecosystem of cetaceans; analytics and correlative analysis may be used to form recommendations for stakeholders 334 to make informed decisions regarding shipping routes and potential alterations which may help to minimize the impact of the watercraft on the cetaceans.

The navigation and protection system 340 may be used to report detected (e.g., via satellite imagery 216 obtained via the data collection system 210 of FIG. 2) violations of laws, treaties, regulations, and other obligations. The navigation and protection system 340 may report the data to interested agencies, stakeholders 334, and/or others of interest. The navigation and protection system 340 may suggest policing and policy measures to prevent future violations. Policy measures may include, for example, incentivizing (e.g., via financial incentives) nations and organizations to comply with guidelines and regulations.

The navigation and protection system 340 may recommend measures to protect the food chain of cetaceans such as prohibiting certain types of fishing methods in regions known to host cetacean pods. The navigation and protection system 340 may track and share information on cetacean concentrations in oceans with vessels navigating oceans to prevent collisions and/or other accidents; the tracking and sharing of information may be done continually to provide updated and even instantaneous data to the vessels. The navigation and protection system 340 may build a navigational re-route direction for the ships; component analytics, such as those used in dynamic rerouting algorithms, may be used to re-route the vessels.

The subsystem 300 may include a carbon measurement system 350. The carbon measurement system 350 may map carbon footprint 352 and track carbon changes 354. The carbon measurement system 350 may capture and/or track data about cetaceans (e.g., population in a given region), phytoplankton (e.g., estimate the growth thereof), and carbon (e.g., carbon footprint and/or atmospheric carbon dioxide). The carbon measurement system 350 may capture and/or track data continuously to record granular data for precise information and correlation.

The carbon measurement system 350 may measure the impact and/or results of any actions taken in accordance with the disclosure. The carbon measurement system 350 may use this information directly and/or feed it into an analysis engine (e.g., the analysis and processing system 220 of FIG. 2) to continually improve a system for carbon footprint reduction (e.g., the system 100 shown in FIG. 1).

The carbon measurement system 350 may measure the effects and/or results (e.g., a change in carbon and/or oxygen concentration and/or release rates) and calibrate policy recommendations (e.g., such as those used to inform policy 344) accordingly. In some embodiments, the carbon measurement system 350 may use a carbon footprint monitoring system that correlates with cetacean census and protective measures.

The carbon measurement system 350 may identify effective measures for reducing fatality of cetaceans; for example, the downstream effect of reduced carbon footprint may be quantified over time (e.g., the downstream effects after a few years). The carbon measurement system 350 may identify measures that are less effective or ineffective; a root cause analysis may be performed, and course corrections may be made with respect to the policy recommendations to improve their effectiveness and impact. Various methods may be used to identify more and less effective recommendations and policies such as, for example, statistical inferencing methods.

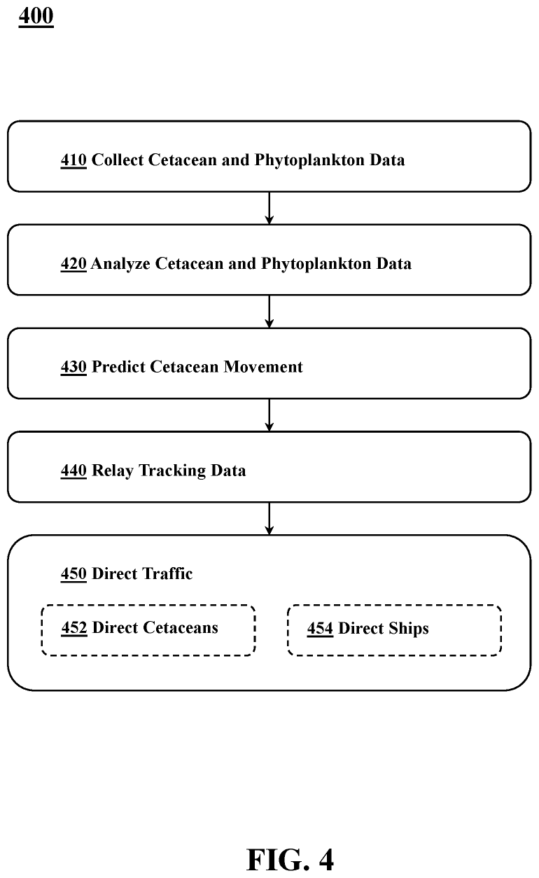

FIG. 4 depicts a method 400 in accordance with some embodiments of the present disclosure. The method 400 may include collecting 410 data, analyzing 420 the data, predicting 430 expectations based on the data, relaying 440 information, and directing 450 traffic according to the information.

The method 400 may include collecting 410 data. Collecting 410 data may include gathering input from one or more sources which may garner insight as to the numbers and locations of one or more cetaceans or populations of cetaceans. The method 400 may include analyzing 420 the collected data and predicting 430 expectations based on the collected data and the analysis thereof.

The method 400 may include relaying 440 information and directing 450 traffic based on the relayed information. Relayed information may include, for example, cetacean presence and numbers, vessel size, collision data (e.g., number or percentage of collisions), detectability of cetacean pods by ships, identified pods or clusters of cetaceans in a region, and similar information. Directing 450 traffic may include directing cetaceans 452 and/or directing ships 454. In some embodiments, ships will be directed away from cetaceans and/or known cetacean migration routes. Traffic may be directed to prevent collisions between cetaceans and ships.

In some embodiments, a system in accordance with the present disclosure and/or associated with the method 100 may include a memory and a processor in communication with the memory. The processor may be configured to perform operations. The operations may include collecting organism data and analyzing the organism data. The operations may also include predicting an organism movement pattern based on the organism data and relaying the organism movement pattern to a participant.

In some embodiments, the operations of a system in accordance with the present disclosure may include routing a vessel away from said organism movement pattern.

In some embodiments, the operations of a system in accordance with the present disclosure may include generating a navigational route for a vessel based on said organism data.

In some embodiments, the operations of a system in accordance with the present disclosure may include measuring an impact of said relaying said organism movement pattern to said participant. Some embodiments may include accepting said impact as a feedback input. Some embodiments may include mapping a carbon footprint based on said impact.

In some embodiments, the operations of a system in accordance with the present disclosure may include directing traffic based on said organism data.

In some embodiments, the operations of a system in accordance with the present disclosure may include recommending a policy to said participant. Some embodiments may include predicting an impact of said policy.

In some embodiments, the organism may be a cetacean.

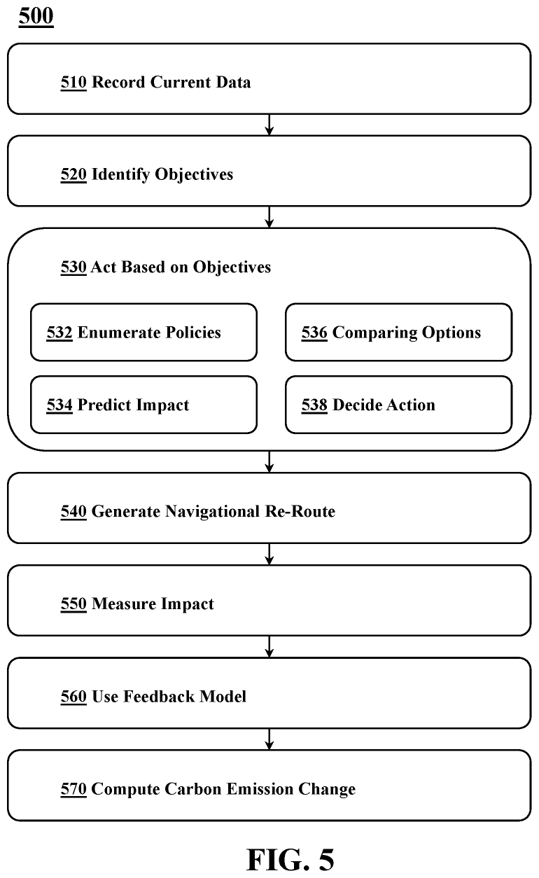

FIG. 5 illustrates a method 500 in accordance with some embodiments of the present disclosure. The method 500 includes recording 510 current data and identifying 520 objectives. The method 500 further includes acting 530 based on objectives; acting 530 may include enumerating 532 policies, predicting 534 the impact of those policies, comparing 536 options, and deciding 536 which action or actions to pursue.

The method 500 further includes generating 540 at least one navigational re-route and measuring 550 the impact of the actions taken. Data may be collected from measuring 550 the impact. Measuring 550 the impact may be done by assessing the current cetacean population, the growth rate of the cetaceans, and the fatality rate of cetaceans.

A yearly geometric progression may be used to detect and/or calculate the growth rate of cetaceans. For example, a growth rate may be calculated by:

$${r}_{G} = \frac{G - {G}^{′}}{{G}^{′} - 1} \qquad Eq . 1$$

wherein r_{G} is the growth ratio, G is the current growth rate, and G′ is the previous growth rate, such that:

G₁=C₁·(1+r)ⁿ Eq. 2:

wherein G₁ is a growth rate of cetaceans in a first region, C₁ is the current number of cetaceans (e.g., the humpback whale population) in the first region, r is the ratio of the common growth expected for that cetacean population (e.g., as derived from the current growth rate), and n is time measured in years. The region may be any size area; for example, the region may be a hundred square miles at selected coordinates, a specified ocean, or include the entire globe (e.g., all of the oceans).

Similar to a growth rate G, a fatality rate may be calculated by:

$${r}_{F} = \frac{F - {F}^{′}}{{F}^{′} - 1} \qquad Eq . 3$$

wherein r_{F} is the fatality ratio, F is the current fatality rate, and F′ is the previous fatality rate, such that:

F₁=C₁·(1+r_{F})ⁿ Eq. 4:

wherein F₁ is a fatality rate of cetaceans in a first region and r_{F} is the ratio of the fatality expected for that cetacean population (e.g., as derived from the current fatality rate).

The current population of cetaceans in a region C₁ at any given time may be calculated by:

C₁=(G+G₁)−(F+F₁) Eq. 5:

A carbon footprint factor F_{CF} over time n may be calculated by:

F_{CF}=([G·x]+[F_{P}])·n Eq. 6:

wherein x is a carbon emission factor per cetacean (e.g., the average amount of carbon one cetacean prevents from entering the atmosphere) and F_{P} is a phytoplankton carbon emission factor (e.g., the effect of phytoplankton on atmospheric carbon).

A total carbon footprint F_{Total} (e.g., a global carbon footprint F_{Global}) may be calculated by:

F_{Total}=Σ_{R}F_{CF}

wherein R is the total number of regions represented in the total carbon footprint F_{Total}.

Collected and calculated data may be used to improve the system (e.g., a system 100 as shown in FIG. 1) via feedback. The method 500 may include using 560 a feedback model and computing 570 the carbon emission change based on the collected data.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment currently known or that which may be later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but the consumer has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software which may include operating systems and applications. The consumer does not manage or control the underlying cloud infrastructure but has control over operating systems, storage, and deployed applications, and the consumer possibly has limited control of select networking components (e.g., host firewalls).

Deployment models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and/or compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

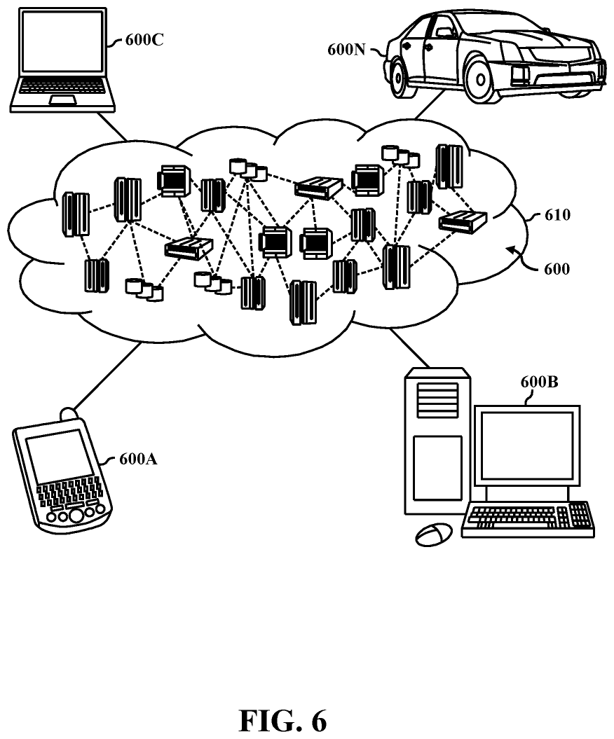

FIG. 6 illustrates a cloud computing environment 610 in accordance with embodiments of the present disclosure. As shown, cloud computing environment 610 includes one or more cloud computing nodes 600 with which local computing devices used by cloud consumers such as, for example, personal digital assistant (PDA) or cellular telephone 600A, desktop computer 600B, laptop computer 600C, and/or automobile computer system 600N may communicate. Nodes 600 may communicate with one another. They may be grouped (not shown) physically or virtually, in one or more networks, such as private, community, public, or hybrid clouds as described hereinabove, or a combination thereof.

This allows cloud computing environment 610 to offer infrastructure, platforms, and/or software as services for which a cloud consumer does not need to maintain resources on a local computing device. It is understood that the types of computing devices 600A-N shown in FIG. 6 are intended to be illustrative only and that computing nodes 600 and cloud computing environment 610 can communicate with any type of computerized device over any type of network and/or network addressable connection (e.g., using a web browser).

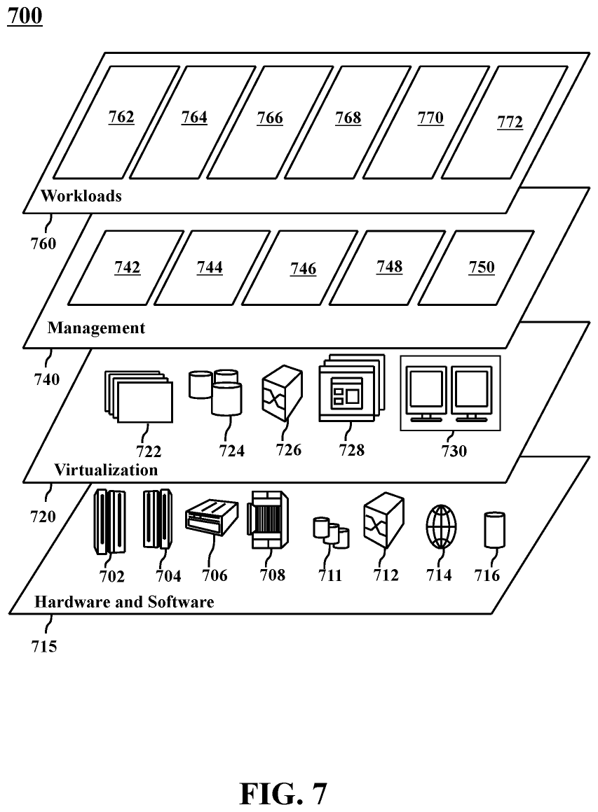

FIG. 7 illustrates abstraction model layers 700 provided by cloud computing environment 610 (FIG. 6) in accordance with embodiments of the present disclosure. It should be understood in advance that the components, layers, and functions shown in FIG. 7 are intended to be illustrative only and embodiments of the disclosure are not limited thereto. As depicted below, the following layers and corresponding functions are provided.

Hardware and software layer 715 includes hardware and software components. Examples of hardware components include: mainframes 702; RISC (Reduced Instruction Set Computer) architecture-based servers 704; servers 706; blade servers 708; storage devices 711; and networks and networking components 712. In some embodiments, software components include network application server software 714 and database software 716.

Virtualization layer 720 provides an abstraction layer from which the following examples of virtual entities may be provided: virtual servers 722; virtual storage 724; virtual networks 726, including virtual private networks; virtual applications and operating systems 728; and virtual clients 730.

In one example, management layer 740 may provide the functions described below. Resource provisioning 742 provides dynamic procurement of computing resources and other resources that are utilized to perform tasks within the cloud computing environment. Metering and pricing 744 provide cost tracking as resources and are utilized within the cloud computing environment as well as billing or invoicing for consumption of these resources. In one example, these resources may include application software licenses. Security provides identity verification for cloud consumers and tasks as well as protection for data and other resources. User portal 746 provides access to the cloud computing environment for consumers and system administrators. Service level management 748 provides cloud computing resource allocation and management such that required service levels are met. Service level agreement (SLA) planning and fulfillment 750 provide pre-arrangement for, and procurement of, cloud computing resources for which a future requirement is anticipated in accordance with an SLA.

Workloads layer 760 provides examples of functionality for which the cloud computing environment may be utilized. Examples of workloads and functions which may be provided from this layer include: mapping and navigation 762; software development and lifecycle management 764; virtual classroom education delivery 766; data analytics processing 768; transaction processing 770; and one or more systems for protecting cetaceans 772.

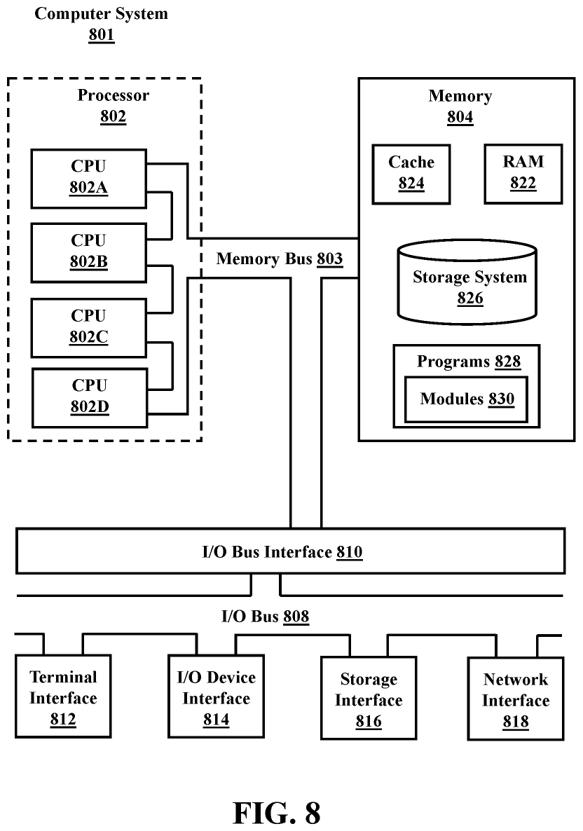

FIG. 8 illustrates a high-level block diagram of an example computer system 801 that may be used in implementing one or more of the methods, tools, and modules, and any related functions, described herein (e.g., using one or more processor circuits or computer processors of the computer) in accordance with embodiments of the present disclosure. In some embodiments, the major components of the computer system 801 may comprise a processor 802 with one or more central processing units (CPUs) 802A, 802B, 802C, and 802D, a memory subsystem 804, a terminal interface 812, a storage interface 816, an I/O (Input/Output) device interface 814, and a network interface 818, all of which may be communicatively coupled, directly or indirectly, for inter-component communication via a memory bus 803, an I/O bus 808, and an I/O bus interface unit 810.

The computer system 801 may contain one or more general-purpose programmable CPUs 802A, 802B, 802C, and 802D, herein generically referred to as the CPU 802. In some embodiments, the computer system 801 may contain multiple processors typical of a relatively large system; however, in other embodiments, the computer system 801 may alternatively be a single CPU system. Each CPU 802 may execute instructions stored in the memory subsystem 804 and may include one or more levels of on-board cache.

System memory 804 may include computer system readable media in the form of volatile memory, such as random access memory (RAM) 822 or cache memory 824. Computer system 801 may further include other removable/non-removable, volatile/non-volatile computer system storage media. By way of example only, storage system 826 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM, or other optical media can be provided. In addition, memory 804 can include flash memory, e.g., a flash memory stick drive or a flash drive. Memory devices can be connected to memory bus 803 by one or more data media interfaces. The memory 804 may include at least one program product having a set (e.g., at least one) of program modules that are configured to carry out the functions of various embodiments.

One or more programs/utilities 828, each having at least one set of program modules 830, may be stored in memory 804. The programs/utilities 828 may include a hypervisor (also referred to as a virtual machine monitor), one or more operating systems, one or more application programs, other program modules, and program data. Each of the operating systems, one or more application programs, other program modules, and program data, or some combination thereof, may include an implementation of a networking environment. Programs 828 and/or program modules 830 generally perform the functions or methodologies of various embodiments.

Although the memory bus 803 is shown in FIG. 8 as a single bus structure providing a direct communication path among the CPUs 802, the memory subsystem 804, and the I/O bus interface 810, the memory bus 803 may, in some embodiments, include multiple different buses or communication paths, which may be arranged in any of various forms, such as point-to-point links in hierarchical, star, or web configurations, multiple hierarchical buses, parallel and redundant paths, or any other appropriate type of configuration. Furthermore, while the I/O bus interface 810 and the I/O bus 808 are shown as single respective units, the computer system 801 may, in some embodiments, contain multiple I/O bus interface units 810, multiple I/O buses 808, or both. Further, while multiple I/O interface units 810 are shown, which separate the I/O bus 808 from various communications paths running to the various I/O devices, in other embodiments some or all of the I/O devices may be connected directly to one or more system I/O buses 808.

In some embodiments, the computer system 801 may be a multi-user mainframe computer system, a single-user system, a server computer, or similar device that has little or no direct user interface but receives requests from other computer systems (clients). Further, in some embodiments, the computer system 801 may be implemented as a desktop computer, portable computer, laptop or notebook computer, tablet computer, pocket computer, telephone, smartphone, network switches or routers, or any other appropriate type of electronic device.

It is noted that FIG. 8 is intended to depict the representative major components of an exemplary computer system 801. In some embodiments, however, individual components may have greater or lesser complexity than as represented in FIG. 8, components other than or in addition to those shown in FIG. 8 may be present, and the number, type, and configuration of such components may vary.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide, or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN) or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system, said system comprising:
a memory; and
a processor in communication with said memory, said processor being configured to perform operations, said operations comprising:
collecting organism data;
analyzing said organism data;
predicting an organism movement pattern based on said organism data; and
relaying said organism movement pattern to a participant.

2. The system of claim 1, said operations further comprising:
generating a navigational route for a vessel based on said organism data.

3. The system of claim 2, said operations further comprising:
routing a vessel away from said organism movement pattern.

4. The system of claim 1, said operations further comprising:
measuring an impact of said relaying said organism movement pattern to said participant.

5. The system of claim 1, said operations further comprising:
directing traffic based on said cetacean data.

6. The system of claim 1, said operations further comprising:
recommending a policy to said participant.

7. The system of claim 6, said operations further comprising:
predicting an impact of said policy.

8. The system of claim 1, wherein:
said organism is a cetacean.

9. A method, said method comprising:
collecting organism data;
analyzing said organism data;
predicting an organism movement pattern based on said organism data; and
relaying said organism movement pattern to a participant.

10. The method of claim 9, further comprising:
generating a navigational route for a vessel based on said organism data.

11. The method of claim 10, further comprising:
routing a vessel away from said organism movement pattern.

12. The method of claim 9, further comprising:
measuring an impact of said relaying said organism movement pattern to said participant.

13. The method of claim 9, further comprising:
directing traffic based on said organism data.

14. The method of claim 9, further comprising:
recommending a policy to said participant.

15. The method of claim 9, wherein:
said organism is a cetacean.

16. A computer program product, said computer program product comprising a computer readable storage medium having program instructions embodied therewith, said program instructions executable by a processor to cause said processor to perform a function, said function comprising:
collecting organism data;
analyzing said organism data;
predicting an organism movement pattern based on said organism data; and
relaying said organism movement pattern to a participant.

17. The computer program product of claim 16, said function further comprising:
generating a navigational route for a vessel based on said organism data.

18. The computer program product of claim 16, said function further comprising:
measuring an impact of said relaying said organism movement pattern to said participant.

19. The computer program product of claim 16, said function further comprising:
recommending a policy to said participant.

20. The computer program product of claim 16, wherein:
said organism is a cetacean.
